(19) United States
(12) Patent Application Publication
(10) Pub. No.: US 2001/0048730 A1
(43) Pub. Date: Dec. 6, 2001

(54) Method of highly sensitive analysis of nuclides by multiple gamma-ray detection

(76) Inventors: Masumi Oshima, Ibaraki (JP); Yuichi Hatsukawa, Ibaraki (JP); Takehito Hayakawa, Ibaraki (JP); Yosuke Toh, Ibaraki (JP); Nobuo Shinohara, Ibaraki (JP)

Correspondence Address: BANNER & WITCOFF, 1001 G STREET N W, SUITE 1100, WASHINGTON, DC, 20001, US

(21) Appl. No.: 09/873,312

(22) Filed: Jun. 5, 2001

(30) Foreign Application Priority Data
Jun. 6, 2000 (JP) 168638/2000

(51) Int. Cl. G21G 1/12

(52) U.S. Cl. 376/157

(57) ABSTRACT

Two gamma-rays emitted simultaneously from each of the radionuclides in a radioactivated sample are simultaneously measured with a multiple gamma-ray detector assembly to construct a two-dimensional matrix rather than a one-dimensional spectrum, and the individual nuclides are measured in a completely separate form without performing any artificial operation such as chemical separation.

### BACKGROUND OF THE INVENTION

This invention relates to the application of multiple gamma-ray detection to qualitative and quantitative determination of radionuclides or nuclides in samples radioactivated by neutrons or other particle rays or gamma-rays. The multiple gamma-rays emitted from the nuclides are measured simultaneously and information is taken for a pair of gamma-rays from each nuclide, thereby analyzing the nuclides at higher resolution than the conventional measurement of gamma-rays.

According to the invention, concurrent gamma-rays emitted from radionuclides are counted simultaneously with a multiple gamma-ray detector assembly consisting of a plurality of gamma-ray detectors to make a two-dimensional matrix, which is analyzed to ensure that the nuclides of interest are separated completely and analyzed simultaneously.

The resolution that can be achieved by the prior art method of analysis has been about 1,000 and this is increased by a factor of 1,000 to 1,000,000 in the improved method of the invention which analyzes a two-dimensional matrix. This resolution is high enough to enable complete separation of nuclides in a sample no matter how many they are. Consider an unreal situation where a maximum of 2,000-3,000 nuclides known today are generated simultaneously in an accelerator or a reactor; since they each generate about 10 gamma-rays on the average, the maximum total number of gamma-rays that are emitted is on the order of 10,000 but given the resolution of 1,000,000, their amounts can be determined simultaneously by analysis of a two-dimensional matrix according to the invention.

In the conventional analysis of radioactivity, gamma-rays emitted from radionuclides are measured with a single unit of germanium semiconductor detector to obtain a one-dimensional energy spectrum and the nuclides of interest are identified on the basis of energy and half-life information. The resolution by the germanium detector is about 1,000 at 1 MeV. The number of gamma-rays emitted from one radionuclide is on the order of ten at average and there is no problem with a sample containing a limited number of nuclides. However, a sample containing several tens of nuclides emit as many as several hundred gamma-rays and it is impossible to separate them completely. In particular, weak gamma-rays are blocked by strong gamma-rays and cannot be analyzed.

To analyze non-radioactive samples, they are first radioactivated by particles from an accelerator or a reactor and the gamma-rays emitted from the sample are detected (for qualitative analysis) and their intensity is measured (for quantitative analysis). In this neutron radio-activation analysis method, the sample of interest is radioactivated by neutrons from a reactor and the gamma-rays emitted from the sample are measured with a single unit of high-resolution germanium detector to produce a one-dimensional spectrum which is analyzed for peaks, thereby performing quantitative determination.

The analyses described above have been conducted in many fields by various methods and the radioactivation analysis method has seen particularly wide use. Since the development of the germanium semiconductor detector in the sixties, radioactivation analysis using gamma-rays capable of high-resolution detection has made great advances and it is now possible to quantify trace elements in various samples including environmental samples, bio-samples and samples for use in space and earth science studies.

FIG. 1 shows a conventional method of gamma-ray measurement by radioactivation. A sample 1 radioactivated by thermal neutrons from a reactor emits gamma-rays which are measured with a single unit of germanium detector 2 to construct a one-dimensional spectrum 3 plotting count (intensity) on the vertical axis and the energy of gamma-rays on the horizontal axis. If the sample contains many elements, this method yields such a complex spectrum that it is often difficult to measure the elements of interest in separate form.

A major problem of the prior art methods is their high susceptibility to interference by concomitant nuclides. If you are lucky enough, there is no overlap between gamma-rays but if the sample contains many nuclides, the spectrum has such a high background that it is very difficult to detect weak gamma-rays.

To eliminate the adverse effects of interfering nuclides, samples such as spent nuclear fuels that contain many nuclides are usually subjected to chemical separation or differentiation of nuclides by half-life. However, chemical separation usually requires special skills and prolonged time; in addition, it is necessary to determine the yield of chemical separation but this can be a source of errors. Differentiation by half-life is not an ideal method, either. Considerable time is taken to determine the quantity of a nuclide of long half-life and it is quite cumbersome to maintain the detector system throughout that period.

Thus, the conventional techniques are highly susceptible to the interference by concomitant nuclides and samples such as environmental samples that contain many elements have to be subjected to chemical separation in order to eliminate the adverse effects of the interfering nuclides. For chemical separation, its yield must be determined and this in turn necessitates re-radioactivation; hence, chemical separation requires special skills and prolonged time but this can be a source of errors.

In the conventional method of radioactivation analysis, a sample radioactivated by neutrons from a reactor is measured with a single unit of germanium detector to construct a one-dimensional spectrum and the peaks in the spectrum are analyzed to determine the quantities of elements in the sample. If the sample contains many elements, the relative intensity of generated radioactivity is not distributed among all nuclides present but assigned to only limited nuclides and it is difficult to identify trace elements without chemical separation; however, errors in the percent efficiency of recovery achieved after separation not only affect the result to be finally obtained, separation also requires sophisticated skills of chemical analysis.

In the method of neutron radioactivation analysis, the relative intensity of generated radioactivity is not generally distributed among all nuclides present but assigned to only limited nuclides and it is often difficult to perform simultaneous analysis of many trace elements. For example, bio-samples have strong radioactivity from ²⁴Na, ⁵⁶Mn, ⁴²K and ⁸²Br and geological samples from ²⁴Na, ⁵⁶Mn, ⁴²K, ⁴⁶Sc and ⁵⁹Fe; hence, in the method of analyzing a one-dimensional spectrum with a single detector unit, the peaks of short-lived nuclides are masked by these strong nuclides and cannot be detected. To deal with this problem, radioactivity measurement has to be performed after strong radioactive nuclides are removed by chemical separation. This not only requires sophisticated skills of chemical analysis; after chemical separation, re-radioactivation has to be performed in the reactor to determine the percent recovery of the desired nuclide. A further concern is the possibility that the precision of analysis may be affected by the process of chemical separation.

### SUMMARY OF THE INVENTION

Noting that many radioactive nuclides emit a plurality of gamma-rays, the present inventors devised a method of qualitative and quantitative determination of these nuclides by analyzing a two-dimensional matrix obtained by measuring them with a multiple gamma-ray detector assembly consisting of a plurality of gamma-ray detectors. The method achieved 1,000 times as high an energy resolution as the conventional method of analyzing a one-dimensional spectrum.

The two-dimensional matrix method of the invention comprises the steps of detecting a plurality of concurrent gamma-rays from radioactive nuclides in a sample with two or more detectors in a multiple gamma-ray detector assembly, cumulatively adding the energies of a pair of detected gamma-rays on a two-dimensional matrix, and detecting the peaks. The background of a one-dimensional spectrum is localized in a two-dimensional plane, being limited to less than 10 counts in almost all regions; hence, even very weak peaks are sufficiently detected to achieve higher detection sensitivity.

In addition, the method of the invention does not require chemical separation or any other artificial operations and, hence, can be performed on-line with a computer. Once preliminary calibration has been done for the energy of each detector and the efficiency of detection, a two-dimensional matrix is generated as the sample is measured; the position of a particular peak on the matrix tells the nuclide it represents and, at the same time, with reference to the nuclear data for each nuclide that is stored in the computer, the quantity of the particular nuclide is determined from the intensity of the peak and real-time display of the result is possible. Needless to say, the quantities of nuclides having long half-life can be determined at high speed.

Similarly, the present invention enables qualitative and quantitative analyses of the nuclides in samples that have been radioactivated with neutrons from an accelerator or a reactor.

### BRIEF DESCRIPTION OF THE DRAWINGS

FIG. 1 shows a conventional method of gamma-ray detection as applied to a radioactivated sample;

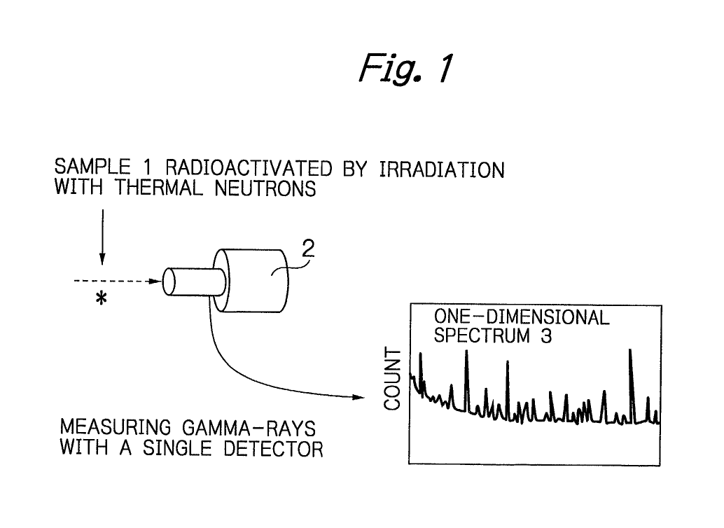

FIG. 2 shows the invention method of gamma-ray detection as applied to a radioactivated sample; and

FIG. 3 shows a two-dimensional matrix constructed by the invention method of gamma-ray detection.

### DETAILED DESCRIPTION OF THE INVENTION

(1) Qualitative and Quantitative Analyses of Nuclides in a Sample Radioactivated with Neutrons

Using a multiple gamma-ray detector assembly consisting of a plurality of germanium semiconductor detectors, a plurality of gamma-rays emitted from a radioactivated sample are measured and combinations of two simultaneously observed gamma-rays are recorded in a computer and then analyzed to construct a two-dimensional matrix. Combining a gamma-ray having a given energy with a concurrently observed gamma-ray, one can construct a neat spectrum which is substantially free from the interference by gamma-rays from dissimilar nuclides. As a result, there is no need to perform artificial operations such as chemical separation and still gamma-rays from trace elements can be measured without interference by gamma-rays from concomitant nuclides.

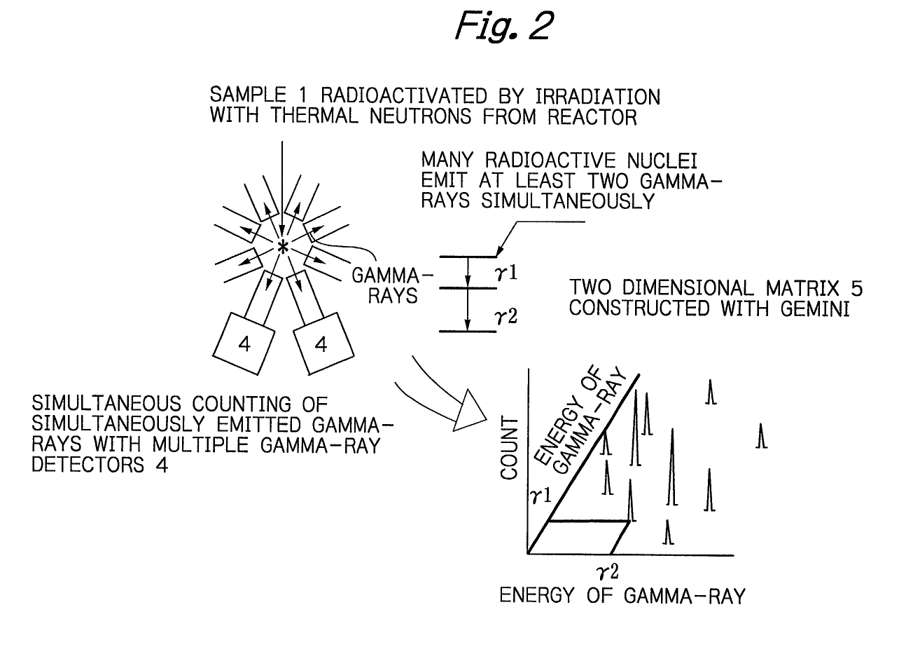

FIG. 2 shows the invention method of gamma-ray detection as applied to a sample 1 radioactivated with thermal neutrons from a reactor. Gamma-rays simultaneously emitted from the sample are measured by simultaneous counting with a multiple gamma-ray detector assembly 4 to construct a two-dimensional matrix 5 which plots the count (intensity) on the vertical axis, the energy of one gamma-ray on the horizontal axis, and the energy of the other gamma-ray on an axis in between the two axes. According to this method, two gamma-rays γ₁ and γ₂ emitted simultaneously from a radioactive nuclide in the sample are measured simultaneously with the multiple gamma-ray detector assembly to construct the two-dimensional matrix rather than a one-dimensional spectrum. As a result, even a sample containing many nuclides can be analyzed for gamma-rays at a resolution of 1,000 without chemical separation or any other artificial operations and this achieves measurement of nuclides in completely separate form. The nuclide of interest can be identified by the position determined by the coordinates (γ₁, γ₂) on FIG. 2 and the amount of its abundance is detected by the height (count) of the peak in that position.

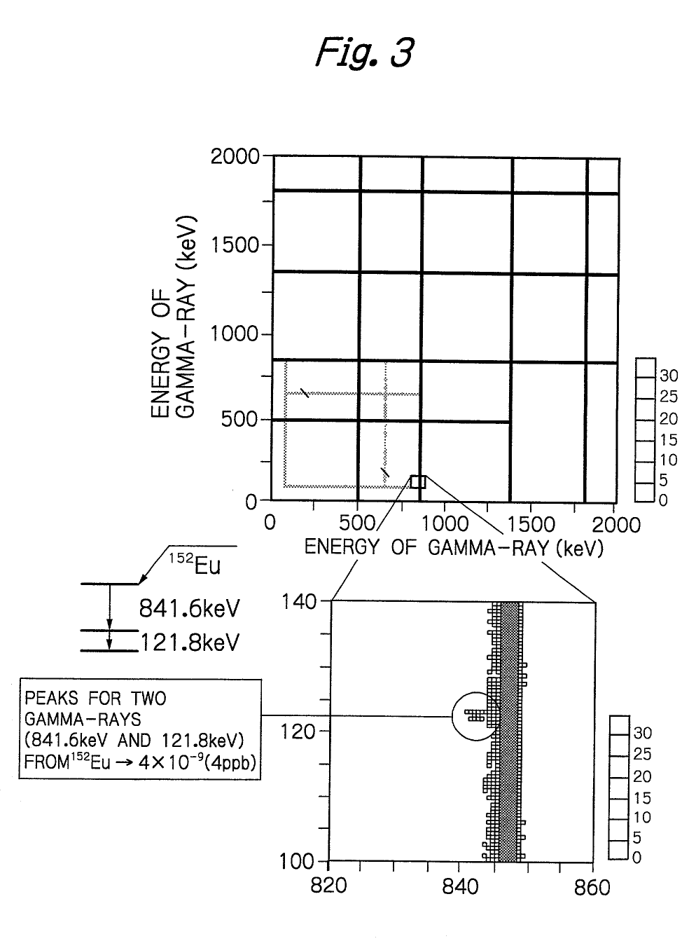

As FIG. 3 shows, radioactivated ¹⁵²Eu generates two gamma-rays simultaneously, one having an energy of 841.6 keV and the other at 121.8 keV. These two gamma-rays were subjected to simultaneous counting with the multiple gamma-ray detector assembly to construct a two-dimensional matrix.

FIG. 3 also shows a graph plotting the energies of the two gamma-rays on the horizontal and vertical axes. The inset for the range of 100-140 keV on the vertical axis and the range of 820-860 keV on the horizontal axis is shown enlarged below the graph. As is clear from the enlarged inset, the two gamma-rays from ¹⁵²Eu having respective energies of 121.8 keV and 841.6 keV were recorded simultaneously and the identity of the nuclide that emitted those gamma-rays could be known by their positions. In this way, the quantities of as many as 49 elements could be determined simultaneously in resolutions up to the ppb (10⁻⁹) order.

The multiple gamma-ray detector assembly used in the present invention has such a high detection efficiency that samples taken in quantities on the milligram order suffice for measurement purposes. Since the method of analysis of the invention is nondestructive, radioactivated samples can be subjected as such to measurement and this provides not only great convenience but also applicability to a wide range of samples. For example, the method has potential applications in the quantitative determination of trace metal elements in environmental and bio-samples, as well as in earth science and space science for analysis of meteorites.

Dating techniques using ¹²⁹I (half life of 1.57×10⁷ yr) and ²⁴⁴Pu (8.08×10⁷ yr) have recently been proposed and the method of this invention can be applied to analyze these nuclides. Knowledge is increasing about the relationship between the concentrations of trace elements in living organisms and their biological functions. Since the method of the invention is capable of measuring a wide range of elements simultaneously, it can be used to determine the quantities of heretofore unidentifiable trace elements so that their effects are studied for the first time.

(2) Qualitative and Quantitative Analyses of Nuclides in a Radioactive Sample

Using a multiple gamma-ray detector assembly consisting of a plurality of gamma-ray detectors, a plurality of gamma-rays emitted simultaneously from a radioactive sample were measured and energy information about a pair of emitted gamma-rays was recorded in a computer for each event and then analyzed to construct a two-dimensional matrix. Intensity measurement was done on the matrix. Alternatively, a narrow gate may be set on one of the two axes, one-dimensional spectra are sliced and the intensities of two-dimensional peaks are effectively measured. By preliminary calibration of the energies of gamma-rays and their intensities, the channels and areas of the two-dimensional peaks can be transformed to energy and intensity, respectively. Based on these data, one can perform quantitative determination of nuclides.

The procedure described can be performed on-line if the detectors are preliminarily calibrated against a standard radiation source. Specifically, a standard radiation source with known energy and intensity is measured and calibration data for energy and detection efficiency are prepared for each detector. As an actual sample is measured, each detector is calibrated for energy so as to construct a two-dimensional matrix. At the same time, the nuclear data for each nuclide that are stored in the computer are referenced to determine the quantities of nuclides from the intensities of peaks in the matrix on the basis of the calibrated data for detection efficiency, whereby the result is displayed on a real-time basis. Needless to say, the quantities of long-lived nuclides can be determined without waiting for the disappearance of short-lived nuclides and this permits faster analysis.

The multiple gamma-ray detector assembly to be used in the invention consists of at least two gamma-ray detectors. Signals from the two detectors are fed to a fast simultaneous counter which chooses only simultaneous counting events. At the same time, the energy information from the two detectors is taken into the computer. On the basis of this information, the correlation between two gamma-rays is represented on a two-dimensional matrix by means of a frequency distribution of events. The two-dimensional matrix may be replaced by any suitable equivalents. The performance of the multiple gamma-ray detector assembly improves with the increasing number of detector units and the increasing detection efficiency of each detector unit. If necessary, the multiple gamma-ray detector assembly may be combined with a BGO suppressor to suppress the background and provide higher sensitivity.

The following examples are provided for the purpose of further illustrating the present invention.

### EXAMPLE 1

Quantitative Determination of Trace Elements by Neutron Radioactivation Method

Standard rock samples were irradiated with neutrons in a reactor and the gamma-rays from the radioactivated samples were measured with a multiple gamma-ray detector assembly. The gamma-rays emitted from about 100 mg of each sample that had been radioactivated for 10 minutes in the reactor were measured with the multiple gamma-ray detector assembly for about 4 days. Specifically, standard rock samples JB-1 and JP-1 published by the Geological Survey of Japan, Agency of Industrial Science and Technology, MITI (now the National Institute of Advanced Industrial Science and Technology), were irradiated with neutrons in JAERI Research Reactor JRR-4 and subjected to a four-day measurement with a multiple gamma-ray detector assembly “GEMINI” in the tandem accelerator facilities at JAERI Tokai Research Establishment.

The measurement started immediately after the neutron irradiation and the quantities of as many as 27 nuclides could be determined simultaneously within a short time; no artificial operations such as chemical separation were performed and there was no need to wait for the decay of short-lived nuclides. The contents of the measured elements as calculated from the intensities of gamma-rays agreed with the documented values within the range of errors. The same technique could perform simultaneous quantification of 49 elements. Since the two-dimensional matrix had such a reduced amount of background that it allowed for detection of very weak peaks and the relative abundances of nuclides that could be determined quantitatively were on the order of 10⁻⁹ (one billionth).

The multiple gamma-ray detector assembly “GEMINI” used in Example 1 was a spherical array of anti-Compton gamma-array detectors each being the combination of a BGO Compton suppressor and a germanium detector and capable of lower background and higher resolution. GEMINI was completed in July 1998 and its primary objective is to measure gamma-rays from highly excited atomic nuclei produced by various nuclear reactions and to investigate their internal structures. GEMINI has achieved many results in nuclear spectroscopic experiments using heavy ion beams at JAERI Tokai tandem accelerator facilities.

The forty-nine elements that could for the first time be quantitated simultaneously by the new detection method of the invention were the following: Ag, As, Ba, Br, Ca, Cd, Ce, Cl, Co, Cs, Er, Eu, Fe, Ga, Gd, Ge, Hf, Hg, I, In, Ir, K, La, Lu, Mn, Mo, Na, Nd, Ne, Ni, Os, Pt, Ra, Rb, Re, Ru, Sb, Sc, Se, Sm, Sn, Ta, Tb, Th, Ti, U, W, Yb and Zn; the detection limits of these elements were 10⁻² to 10⁻³ on a weight basis.

On the other hand, the conventional radioactivation method of analysis (using a one-dimensional spectrum) was capable of simultaneous quantification of the following twenty-three elements: Al, Ar, Au, Cr, Cu, Dy, F, Ho, Kr, Mg, Nb, Pd, Pr, Rh, S, Sr, Te, Tl, Tm, V, Xe, Y and Zr; the detection limits of these elements were 10⁻² to 10⁻³ on a weight basis.

### EXAMPLE 2

Analysis of Actinides

Obtaining basic data for the nuclear transformation of minor actinides constitute an important basic portion of nuclear research. The quantification of minor actinides which is necessary for this purpose has primarily relied upon the measurement of alpha-rays. Alpha-rays need be detected in high resolution since nuclides of similar atomic numbers emit alpha-rays of similar energies. However, alpha-rays lose so large amounts of energy as they pass through a medium that it has been necessary for the sample to be first subjected to chemical separation to remove impurities, then dried out and processed into a thin radiation source. This has not only required special skills, it has sometimes been difficult to achieve high enough separation efficiency.

These problems are free from the multiple gamma-ray detection method and high-precision analysis can be accomplished without chemical separation although the method requires the emission of multiple gamma-rays. As a matter of fact, in the measurement of ²³⁷Np standard radiation source using GEMINI, nuclides of intensities as low as 0.01 Bq could be measured in complete isolation from other nuclides.

Geological samples irradiated with neutrons usually emit strong gamma-rays from ²⁴Na and ⁵⁶Mn, making it difficult to measure gamma-rays from trace elements. The multiple gamma-ray analysis method of the invention could perform simultaneous measurement of gamma-rays from 27 elements without chemical separation. The contents of the measured elements as calculated from the intensities of gamma-rays agreed with the documented values of the standard rock samples within the range of errors.

These results show that the invention is applicable not only to qualitative analysis but also to quantitative analysis. Among the elements detected, Eu was present in a very small amount of 4 ppb but it could still be measured together with other elements without chemical separation. Given more favorable conditions, the method is applicable to the detection of 49 elements.

A multitude of radionuclides contained in a sample cannot usually be determined quantitatively in a completely separated state for the purpose of quantitative determination. The multiple gamma-ray detection method used in the invention achieves much higher resolution than the conventional method and the nuclides in the sample, no matter how many they are, can be separated and quantified completely without employing chemical separation or other ancillary means.

What is claimed is:

1. A method of analyzing nuclides in a sample by the combination of multiple gamma-ray detection and radioactivation analysis, in which a pair of gamma-rays emitted from each of the nuclides in a sample radioactivated with particle rays such as neutrons or gamma-rays are measured with a multiple gamma-ray detector assembly.

2. The method according to claim 1, wherein a pair of gamma-rays emitted simultaneously from each of the nuclides in the radioactivated sample are measured simultaneously with the multiple gamma-ray detector assembly to construct a two-dimensional matrix, whereby the individual nuclides in the sample are measured discretely without any artificial separating step.

3. A method of analyzing radionuclides by multiple gamma-ray detection comprising the steps of:
measuring a plurality of gamma-rays emitted simultaneously from a number of radionuclides in a sample with a multiple gamma-ray detector assembly consisting of a plurality of gamma-ray detectors;
recording the energy information for the pair of gamma-rays from each nuclide in a computer;
analyzing the recorded data to construct a two-dimensional matrix plotting the energy of one gamma-ray on one of the two axes and the energy of the other gamma-ray on the other axis;
specifying each nuclide from a position plotted on the matrix;
comparing the peak for each nuclide with a standard radiation source having known energy and intensity; and
measuring the content of each nuclide in the sample, thereby performing qualitative and quantitative analyses of each nuclide.
